(19) United States
(12) Patent Application Publication
(10) Pub. No.: US 2015/0200586 A1
(43) Pub. Date: Jul. 16, 2015

(54) Boost DC-DC Converter with Inrush Current Protection Device and Inrush Current Protecting Method

(71) Applicant: Energy Pass Incorporation, Hsinchu City (TW)

(72) Inventors: Meng-Yin Liao, Yunlin County (TW); Chao-Hsuan Liu, New Taipei City (TW); Ying-Che Lo, Tainan City (TW)

(73) Assignee: Energy Pass Incorporation, Hsinchu City (TW)

(21) Appl. No.: 14/153,067

(22) Filed: Jan. 12, 2014

(51) Int. Cl. H02M 1/34; H02M 3/158

(52) U.S. Cl. CPC H02M 1/34; H02M 3/158

(57) ABSTRACT

A boost DC-DC converter with an inrush current protection device is disclosed. The boost DC-DC converter includes an output stage, including a high-side transistor for providing an output current, a low-side transistor for sinking the output current, a pass transistor for passing through the output current to an output node, an inductor coupled to the high-side transistor, the low-side transistor, and the pass transistor for passing through the output current, and an output capacitor coupled to the pass transistor for boosting an output voltage at the output node, and a protection diode parallel connected to the inductor and the low-side transistor for preventing an inrush current from passing through the inductor and the pass transistor to the output node.

### BACKGROUND OF THE INVENTION

1. Field of the Invention

The present invention relates to a boost DC-DC converter with an inrush current protection device and an inrush current protecting method, and more particularly, to a boost DC-DC converter with an inrush current protection device and an inrush current protecting method capable of coupling a diode to provide an inverse current to offset an inrush current originated from power supply, to prevent the devices in the boost DC-DC converter being damaged by the inrush current.

2. Description of the Prior Art

DC-DC converters are widely utilized in power management systems. In general, the DC-DC converters can be classified to three types: buck converter, boost converter, and buck-boost converter. A buck converter is a DC-DC converter with the output voltage lower than the input voltage, a boost converter is a DC-DC converter with the output voltage higher than the input voltage, and a buck-boost converter is a DC-DC converter wherein the output voltage may be higher or lower than the input voltage.

In general, DC-DC converters suffer from inrush currents. An inrush current may occur when power supply is turned on but the internal circuit of a DC-DC converter is not stable yet. Take a boost converter for example, please refer to FIG. 1A, which is a schematic diagram of a conventional output stage 100 of a synchronous boost converter. As shown in FIG. 1A, the output stage 100 includes a high-side transistor 102, a low-side transistor 104, a pass transistor 106, an inductor L1, an output capacitor C1, and two voltage-dividing resistors R1, R2. A current sensing resistor R3 coupled to the low-side resistor 104 may be utilized for current detection. When power supply is being turned on, voltage of the power supply terminal VCC may rise rapidly and an inrush current may be generated and intended to flow from the power supply terminal VCC to the output stage 100 if there is a conductive path to ground in the output stage 100. At this moment, since the internal circuit of the synchronous boost converter is not stable yet, most of the signals in the internal circuit may remain at low voltages. However, the high-side transistor 102 and the pass transistor 106 are usually implemented with p-type metal oxide semiconductor (PMOS) transistors. With the gates of the high-side transistor 102 and the pass transistor 106 remaining at low voltages, both of the transistors may be turned on. As a result, a conductive path may exist in the output stage 100 and the inrush current may flow through the high-side transistor 102, the inductor L1, the pass transistor 106, and the voltage-dividing resistors R1, R2 or other loading devices to ground.

Please refer to FIG. 1B, which is a schematic diagram of a conventional output stage 150 of an asynchronous boost converter. As shown in FIG. 1B, the output stage 150 is similar to the output stage 100, and hence elements and signals with the same functions are denoted by the same symbols. The main difference between the output stage 150 and the output stage 100 is that in the output stage 150, the pass transistor 106 is replaced by a pass diode 156. When power supply is being turned on, voltage of the power supply terminal VCC may rise rapidly and an inrush current may be generated and intended to flow from the power supply terminal VCC to the output stage 150 if there is a conductive path to ground in the output stage 150. At this moment, since the internal circuit of the asynchronous boost converter is not stable yet, most of the signals in the internal circuit may remain at low voltages. However, the high-side transistor 102 is usually implemented with a p-type metal oxide semiconductor (PMOS) transistor. With the gate of the high-side transistor 102 remaining at low voltage, the high-side transistor 102 may be turned on. As a result, a conductive path may exist in the output stage 150 and the inrush current may flow through the high-side transistor 102, the inductor L1, the pass diode 156, and the voltage-dividing resistors R1, R2 or other loading devices to ground.

It is well-known that when an inrush current flows through an electronic device, the electronic device may be damaged. If the electronic device is weak at enduring inrush current, it may be damaged once the inrush current flows through it. If the electronic device is stronger, it may also be damaged since the inrush current may flow through it each time when power supply is turned on. Therefore, there is a need for providing an inrush current protection device to prevent the inrush current from damaging the devices in the output stage of both the synchronous and asynchronous boost converters.

### SUMMARY OF THE INVENTION

It is therefore an objective of the present invention to provide a boost DC-DC converter with an inrush current protection device and an inrush current protecting method capable of coupling a diode to provide an inverse current to offset an inrush current originated from power supply, to prevent the devices in the boost DC-DC converter being damaged by the inrush current.

The present invention discloses a boost DC-DC converter with an inrush current protection device. The boost DC-DC converter comprises an output stage, comprising a high-side transistor for providing an output current, a low-side transistor for sinking the output current, a pass transistor for passing through the output current to an output node, an inductor coupled to the high-side transistor, the low-side transistor, and the pass transistor for passing through the output current, and an output capacitor coupled to the pass transistor for boosting an output voltage at the output node, and a protection diode parallel connected to the inductor and the low-side transistor for preventing an inrush current from passing through the inductor and the pass transistor to the output node.

The present invention further discloses an inrush current protecting method for a boost DC-DC converter. The inrush current protecting method comprises providing an output current to an output node, and preventing an inrush current from flowing to the output node by disposing a protection diode parallel connected to an inductor and a low-side transistor of an output stage of the boost DC-DC converter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a conventional output stage of a synchronous boost converter.

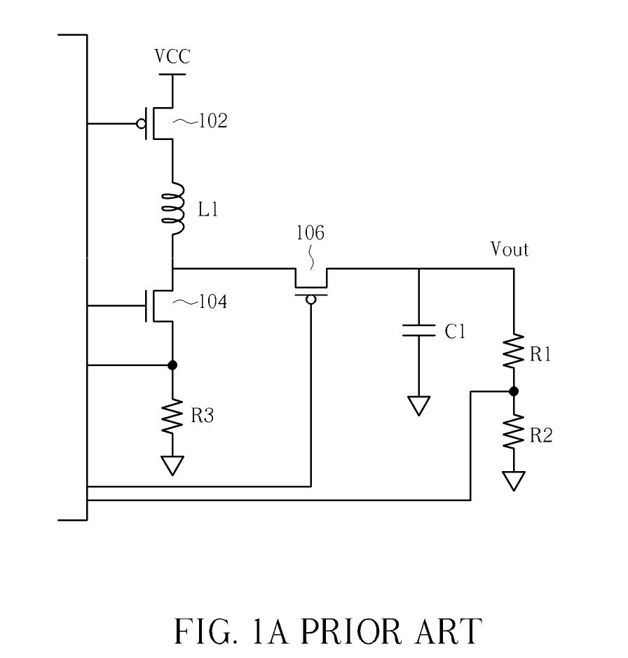

FIG. 1B is a schematic diagram of a conventional output stage of an asynchronous boost converter.

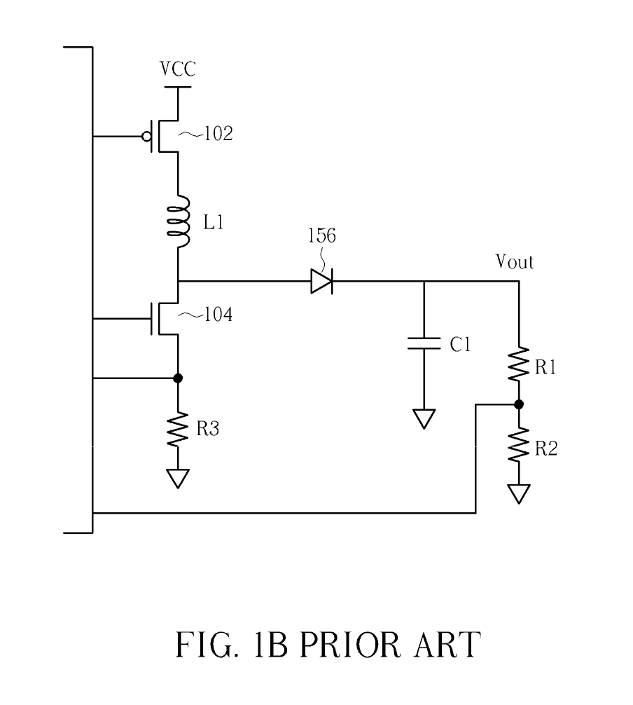

FIG. 2A is a schematic diagram of an output stage of a synchronous boost converter according to an embodiment of the present invention.

FIG. 2B is a schematic diagram of an output stage of an asynchronous boost converter according to an embodiment of the present invention.

FIG. 3 is a waveform diagram of the power supply terminal with and without the protection diode according to an embodiment of the present invention.

### DETAILED DESCRIPTION

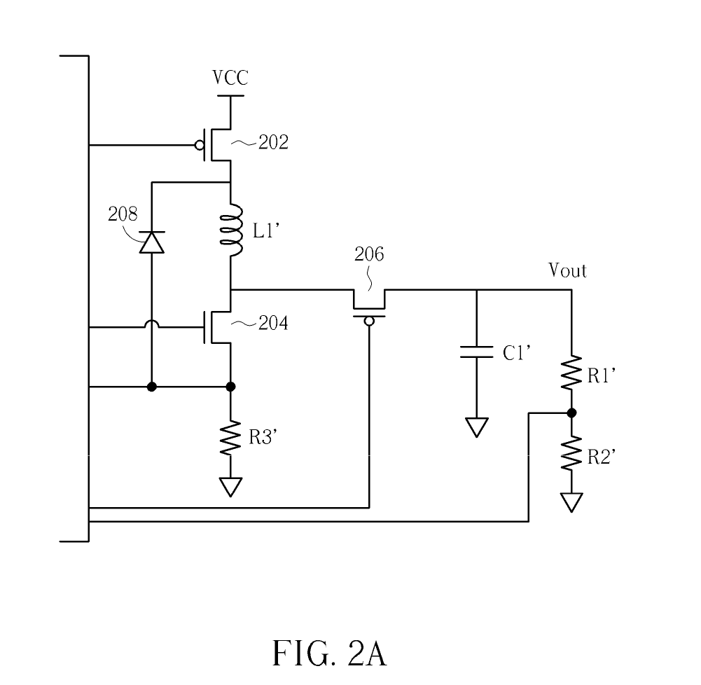

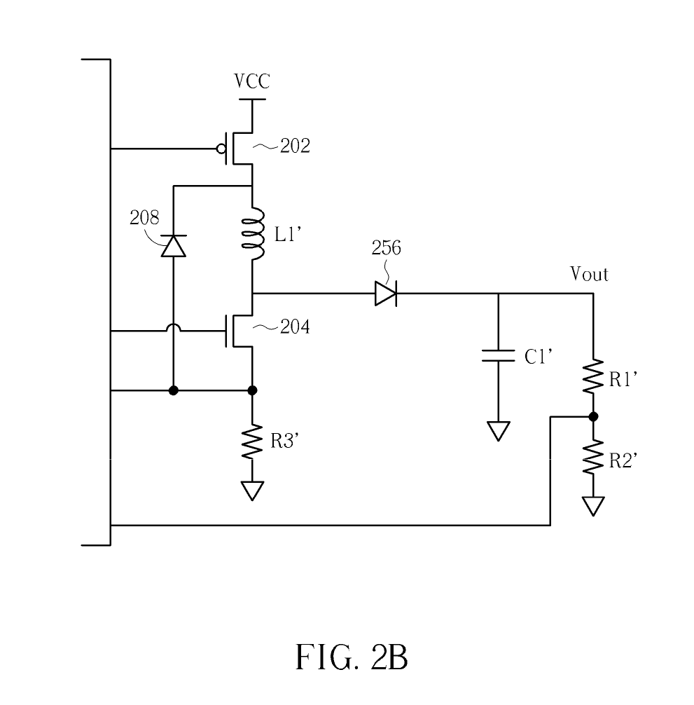

Please refer to FIG. 2A, which is a schematic diagram of an output stage 200 of a synchronous boost converter according to an embodiment of the present invention. As shown in FIG. 2A, the output stage 200 includes a high-side transistor 202, a low-side transistor 204, a pass transistor 206, an inductor L1′, an output capacitor C1′, two voltage-dividing resistors R1′, R2′, a current sensing resistor R3′, and a protection diode 208. The high-side transistor 202 is utilized for providing an output current from the power supply terminal VCC. The low-side transistor 204 is utilized for sinking the output current. The pass transistor 206 is utilized for passing through the output current to an output node Vout. The inductor L1′, coupled to the high-side transistor 202, the low-side transistor 204, and the pass transistor 206, is utilized for passing through the output current. The output capacitor C1′, coupled to the pass transistor 206, is utilized for boosting an output voltage at the output node Vout. The voltage-dividing resistors R1′, R2′ are utilized for adjusting the output voltage. The current sensing resistor R3′, coupled to the low-side resistor 204, may be utilized for current detection. The protection diode 208 is parallel connected to the inductor L1′ and the low-side transistor 204, and is utilized for preventing an inrush current from the power supply terminal VCC to pass through the inductor L1′ and the pass transistor 206 to the output node Vout.

Please refer to FIG. 2B, which is a schematic diagram of an output stage 250 of an asynchronous boost converter according to an embodiment of the present invention. As shown in FIG. 2B, the output stage 250 is similar to the output stage 200, and hence elements and signals with the same functions are denoted by the same symbols. The main difference between the output stage 250 and the output stage 200 is that in the output stage 250, the pass transistor 206 is replaced by a pass diode 256.

In detail, please keep referring to FIG. 2A and FIG. 2B, when power supply is being turned on, voltage of the power supply terminal VCC may rise rapidly and an inrush current may be generated and intended to flow from the power supply terminal VCC to the output stages 200, 250 if there are conductive paths to ground in the output stages 200, 250. At this moment, the protection diode 208 is forward biased and provides an inverse current to offset the inrush current. Though the conductive paths still exist in the output stages 200, 250 (the high-side transistor 202, the inductor L1′, and the pass transistor 206 or the pass diode 256), the inrush current may be offset by the inverse current provided by the protection diode and may become smoother. Therefore, the smoother current may not cause damage to the devices in the output stages 200, 250.

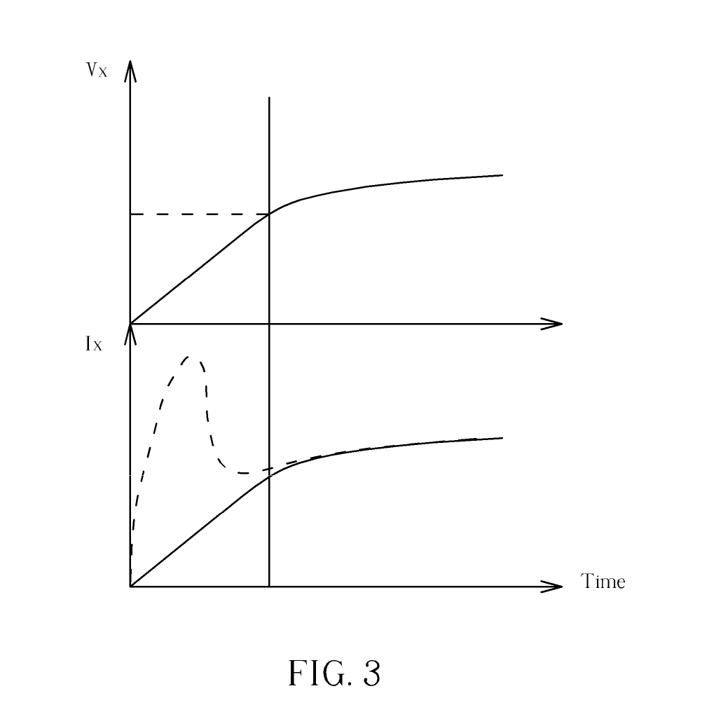

Please refer to FIG. 3, which is a waveform diagram of the power supply terminal VCC with and without the protection diode 208 according to an embodiment of the present invention. As shown in FIG. 3, a voltage Vx denotes the voltage of the power supply terminal VCC, and a current Ix denotes the current flowing from the power supply terminal VCC to the output stages 100, 150, 200, and 250. If the output stages have no protection diode (the output stages 100, 150), the current Ix is plotted with a dotted line. If the output stages have the protection diode 208 (the output stages 200, 250), the current Ix is plotted with a solid line. As shown in FIG. 3, with the protection diode 208, the current Ix becomes smoother and may not cause damage to the devices in the output stages 200, 250.

Please note that, the spirit of the present invention is to prevent an inrush current from damaging the devices in the output stage of the boost converter. Those skilled in the art can make modifications or alterations accordingly. For example, the transistors 202, 204, and 206 in the output stages 200, 250 are all metal oxide semiconductor (MOS) transistors, but in other embodiments, these transistors may also be replaced by bipolar junction transistors (BJTs), which is not limited herein. Besides, in the output stages 200, 250, the protection diode 208 is parallel connected to the inductor L1′ and the low-side transistor 204, but in other embodiments, the protection diode 208 may also be implemented in other ways, as long as the protection diode 208 can provide an additional current to offset the inrush current flowing from the power supply terminal VCC.

In the prior art, when power supply is being turn on, voltage of the power supply terminal may rise rapidly and an inrush current may be generated and intended to flow from the power supply terminal to the output stage of a boost converter if there is a conductive path to ground in the output stage. Hence the devices in the output stage may be damaged by the inrush current. In comparison, the present invention provides a protection diode to provide an inverse current to offset an inrush current originated from the power supply terminal, to prevent the devices in the output stage of the boost converter being damaged by the inrush current.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A boost DC-DC converter with an inrush current protection device, comprising:
an output stage, comprising:
a high-side transistor, for providing an output current;
a low-side transistor, for sinking the output current;
a pass transistor, for passing through the output current to an output node;
an inductor, coupled to the high-side transistor, the low-side transistor, and the pass transistor, for passing through the output current; and
an output capacitor, coupled to the pass transistor, for boosting an output voltage at the output node; and
a protection diode, parallel connected to the inductor and the low-side transistor, for preventing an inrush current from passing through the inductor and the pass transistor to the output node.

2. The boost DC-DC converter of claim 1, further comprising a current sensing device, for detecting the output current.

3. The boost DC-DC converter of claim 2, wherein the current sensing device comprises a resistor.

4. The boost DC-DC converter of claim 1, wherein the protection diode provides an inverse current to offset the inrush current, to prevent the inrush current from passing through the inductor and the pass transistor to the output node.

5. The boost DC-DC converter of claim 1, wherein the boost DC-DC converter is a synchronous boost DC-DC converter.

6. The boost DC-DC converter of claim 1, wherein the boost DC-DC converter is an asynchronous boost DC-DC converter.

7. An inrush current protecting method for a boost DC-DC converter, comprising:
providing an output current to an output node; and
preventing an inrush current from flowing to the output node by disposing a protection diode parallel connected to an inductor and a low-side transistor of an output stage of the boost DC-DC converter.

8. The method of claim 7, further comprising a current sensing device, for detecting the output current.

9. The method of claim 8, wherein the current sensing device comprises a resistor.

10. The method of claim 7, wherein the protection diode provides an inverse current to offset the inrush current, to prevent the inrush current from flowing to the output node.

11. The method of claim 7, wherein the boost DC-DC converter is a synchronous boost DC-DC converter.

12. The method of claim 7, wherein the boost DC-DC converter is an asynchronous boost DC-DC converter.
